(19) United States
(12) Patent Application Publication
(10) Pub. No.: US 2014/0177017 A1
(43) Pub. Date: Jun. 26, 2014

(54) IMAGE DISPLAY DEVICE

(71) Applicant: PIONEER CORPORATION, Kawasaki-shi, Kanagawa (JP)

(72) Inventors: Yoshihisa Kubota, Higashimurayama (JP); Takuma Yanagisawa, Kawasaki-shi (JP)

(73) Assignee: PIONEER CORPORATION, Kawasaki-shi, Kanagawa (JP)

(21) Appl. No.: 14/239,276

(22) PCT Filed: Aug. 31, 2011
(86) PCT No.: PCT/JP2011/069767

§ 371 Date: Mar. 5, 2014

(51) Int. Cl. G02B 27/01

(52) U.S. Cl. CPC G02B 27/0103
USPC 359/13

(57) ABSTRACT

The image display device includes an output unit which outputs an image information light including image information; and a hologram element on which the image information light is incident, and projects the image information light via the hologram element on a retina to make a user visually recognize an image. The hologram element includes a first hologram area and a second hologram area. A first image projected on the retina by a first image information light of the image information light via the first hologram area and a second image projected on the retina by a second image information light of the image information light via the second hologram area are different images.

### TECHNICAL FIELD

The present invention relates to an image display device which makes a user visually recognize an image by projecting a light on retinas of the user.

### BACKGROUND TECHNIQUE

Conventionally, there is known an image display device which projects a light for visually recognizing an image on retinas of a user, by using Maxwellian view. Maxwellian view is a method of projecting a light corresponding to an image on a retina after converging the light once at a center of a pupil. By this method, the image can be observed without being influenced by an adjusting function of a crystalline lens.

For example, Patent Reference 1 proposes a retina projection display method, wherein a holographic optical element is arranged such that the same image has plural convergence points in a whole area of the movable range of a pupil position, and wherein the light passed through any one of the convergence points is directly projected on the retina even when the pupil position is changed. For example, Patent Reference 2 proposes a wide viewing area retina projection-type display system, wherein a liquid crystal display is irradiated with lights from plural point light sources, and wherein the optical system is configured such that the lights passed through the display form convergence points at plural positions in a movable range of the pupil with a predetermined interval. For example, Patent Reference 3 proposes a retina display device, wherein the image cannot be visually recognized when a user gazes the front and the image can be visually recognized when the user directs the eyes to a certain direction.

### PRECEDING TECHNICAL DOCUMENTS

### Patent References

Patent Reference 1: Japanese Patent Application Laid-open under No. 2002-277822

Patent Reference 2: Japanese Patent Application Laid-open under No. 2004-157173

Patent Reference 3: Japanese Patent Application Laid-open under No. 2002-90688

### DISCLOSURE OF INVENTION

### Problem to be Solved by the Invention

Patent References 1 and 2 mentioned above describe a technique of presenting the same image regardless of the visual line direction of the user, and Patent Reference 3 describes a technique of switching between presenting and not presenting the image. However, Patent References 1 to 3 do not describe making the user visually recognize different images when the visual line direction of the user changes, i.e., when the pupil position of the user changes.

The above is an example of a problem to be solved by the present invention. It is an object of the present invention to provide a display device capable of changing the image visually recognized by a user in accordance with the pupil position of the user.

### Means for Solving the Problem

In one invention, an image display device comprises an output unit which outputs an image information light including image information; and a hologram element on which the image information light is incident, and projects the image information light via the hologram element on a retina to make a user visually recognize an image, wherein the hologram element includes a first hologram area and a second hologram area, and wherein a first image that a first image information light of the image information light via the first hologram area projects on the retina and a second image that a second image information light of the image information light via the second hologram area projects on the retina are different images.

In another invention, an image display device projects an image information light, outputted by an output unit for forming an image, on a retina via a hologram element including a first hologram area and a second hologram area, wherein the first hologram area is formed to project a first image on the retina, and wherein the second hologram area is formed to project a second image on the retina.

### BRIEF DESCRIPTION OF THE DRAWINGS

FIGS. 1A and 1B are diagrams schematically showing a configuration of an image display device according to a first embodiment.

FIGS. 2A and 2B are diagrams for concretely explaining an operation by the first embodiment.

FIGS. 3A and 3B are diagrams for explaining formation of a hologram area in consideration of a movement direction of an eyeball of a user.

FIG. 4 is a diagram showing an example, wherein a focal point is not positioned on a pupil.

FIGS. 5A and 5B are diagrams schematically showing a configuration of an image display device according to a second embodiment.

FIGS. 6A and 6B are diagrams schematically showing a configuration of an image display device according to a third embodiment.

FIGS. 7A and 7B are diagrams for concretely explaining an operation by the third embodiment.

FIG. 8 is a diagram schematically showing a configuration of an image display device according to a first modified example.

FIG. 9 is a diagram schematically showing a configuration of an image display device according to a second modified example.

FIG. 10 is a diagram schematically showing a configuration of an image display device according to a third modified example.

### FORMS TO EXERCISE THE INVENTION

According to one aspect of the present invention, there is provided an image display device which comprises an output unit which outputs an image information light including image information; and a hologram element on which the image information light is incident, and which projects the image information light via the hologram element on a retina tomake a user visually recognize an image, wherein the hologram element includes a first hologram area and a second hologram area, and wherein a first image that a first image information light of the image information light via the first hologram area projects on the retina and a second image that a second image information light of the image information light via the second hologram area projects on the retina are different images.

The above image display device includes an output unit and a hologram element, and projects the image information light via the hologram element on a retina tomake a user visually recognize the image. The hologram element includes a first hologram area and a second hologram area. A first image is projected on the retina by a first image information light via the first hologram area, and a second image is projected on the retina by a second image information light via the second hologram area. The first hologram area and the second hologram area are formed such that the first image and the second image are different images. Thus, it is possible to make the user visually recognize different image at each hologram area.

In one mode of the above image display device, the first image information light and the second image information light are concentrated on different positions, respectively. In this mode, the image to be visually recognized by the user can be changed in accordance with the pupil position of the user (in other words, the visual line direction the user).

In another mode of the above image display device, the first image information light and the second image information light are concentrated on different positions, respectively, such that one of the first image information light and the second image information light is projected on the retina in accordance with a movement of an eyeball of the user. In this mode, it is possible to appropriately change the image to be visually recognized by the user, between the first image and the second image, in accordance with the movement of the eyeball of the user, i.e., in accordance with the pupil position of the user.

In still another mode of the above image display device, the first image and the second image are included in the image information, and a positional relation between the first image and the second image in the image information generally corresponds to a positional relation between the first image information light concentrated and the second image information light concentrated. In this mode, the hologram areas are formed on the hologram element at the positions corresponding to the movement direction of the eyeball. Therefore, it is possible to appropriately suppress the wrong feeling that may occur when the hologram areas are formed at the positions not corresponding to the movement direction of the eyeball.

In still another mode of the above image display device, the first hologram area is formed to project the first image information light on the retina when the eyeball of the user is directed to a front, and the second hologram area is formed to project the second image information light on the retina when the eyeball of the user is directed a direction other than the front. In this mode, it is possible to switch the image to be visually recognized by the user, between the first image and the second image, in the cases where the eyeball is directed to the front and where the eyeball is directed to the direction other than the front.

In still another mode of the above image display device, the first hologram area and the second hologram area are formed to project the first image information light and the second image information light on the retina when the eyeball of the user is directed to a direction other than a front. In this mode, the image can be visually recognized only when the eyeball is directed to the direction other than the front.

In still another mode of the above image display device, the first hologram area and the second hologram area are formed to overlap with each other at least partly. In this mode, the first image and the second image overlap with each other at least partly.

In still another mode of the above image display device, the first hologram area and the second hologram area are formed not to overlap with each other. In this mode, the contents of the first image and the second image become different.

Preferably, in still another mode of the above image display device, the first hologram area and the second hologram area deflect the incident image information light to different directions, respectively. By this, the first image information light and the second image information light are concentrated on different positions, respectively.

In a preferred example, the hologram element is formed to transmit the incident image information light.

In another preferred example, the hologram element is formed to reflect the incident image information light. For example, when the hologram element has an optical transparency, it is possible to visually recognize the image information, light and the scene visually recognized through the hologram element.

In a preferred example, the image display device is a scanning-type display which makes the user visually recognize the image by scanning the image information light outputted by the output unit.

In another preferred example, the image display device is a projection-type display which makes the user visually recognize the image by forming the image information light outputted by the output unit into a parallel light flux and passing the parallel light flux through a predetermined optical element.

In another aspect of the present invention, there is provided an image display device which projects an image information light, outputted by an output unit for forming an image, on a retina via a hologram element including a first hologram area and a second hologram area, wherein the first hologram area is formed to project a first image on the retina, and wherein the second hologram area is formed to project a second image on the retina.

In one mode of the above image display device, the first image and the second image are different images.

### EMBODIMENTS

Preferred embodiments of the present invention will be described below with reference to the attached drawings.

### 1st Embodiment

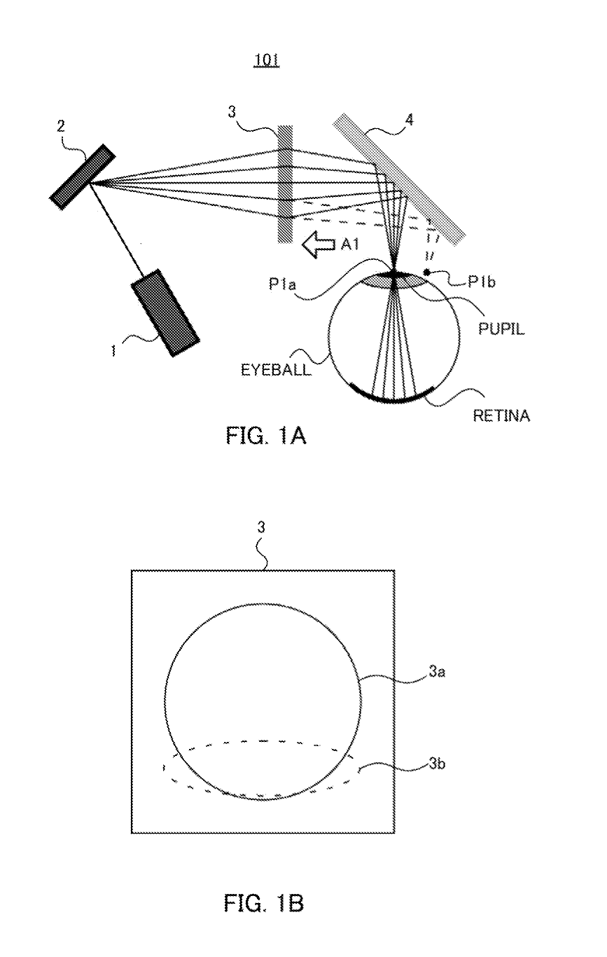

FIGS. 1A and 1B are diagrams schematically showing a configuration of an image display device 101 according to a first embodiment. As shown in FIG. 1A, the image display device 101 mainly includes a laser light source 1, a scan mechanism 2, a hologram element 3 and a beam splitter 4. The image display device 101 is a device which projects an image information light including image information on retinas of a user thereby to make the user visually recognize the image. For example, the image display device 101 is used as a head mount display (HMD).

The laser light source 1 includes a red LD (Laser Diode), a green LD and a blue LD, and emits laser lights (hereinafter simply referred to as “light”) of red, green and blue colors. In addition, the laser light source 1 includes control circuits such as a video ASIC (Application Specific Integrated Circuit) and a laser driver ASIC. For example, the laser light source 1 performs intensity modulation of the laser light in accordance with the image, and emits the laser light, after the intensity modulation. The laser light source 1 corresponds to an example of “an output unit” in the present invention.

The laser light emitted by the laser light source 1 is incident, on the scan mechanism 2. The scan mechanism 2 includes a mirror and an actuator, and deflects the laser light from the laser light source 1 to the hologram element 3. In order to draw the image to be displayed on the retina, the scan mechanism 2 performs the scan operation for changing the position on the retina were the laser is irradiated.

The hologram element 3 is formed as a transmission type, and concentrates the laser light from the scan mechanism 2 to be outputted to the beam splitter 4. The beam splitter 4 reflects the laser light from the hologram element 3 to the eyeball of the user. Thus, the laser light is concentrated on the vicinity of the pupil of the user (including on the pupil. The same will apply in the following description.), and the laser light is projected on the retina of the user. As a result, the image formed by the image display device 101 is visually recognized by the user. The image display device 101 utilizes the principle of Maxwellian view in concentrating the laser light on the vicinity of the pupil of the user.

With reference to FIG. 1B, the hologram element 3 according to the first embodiment will be specifically described. FIG. 1B is a diagram observing the hologram element 3 in the direction shown by the arrow A1 in FIG. 1A.

As shown in FIG. 1B, the hologram element 3 is formed with two hologram areas 3a and 3b. The hologram area 3a is formed over a relatively broad range generally around the center position of the hologram element 3. The hologram area 3b has a size smaller than the hologram area 3a, and is formed at a position apart from the center of the hologram element 3a. The hologram area 3a and the hologram area 3b partly overlap with each other.

The hologram area 3a has a function of concentrating the incident light, and the hologram area 3b has a function of not only concentrating but also deflecting the incident light. Specifically, the hologram area 3b deflects the incident light such that the light outputted from the hologram area 3b travels in a direction different from the direction in which the light outputted from the hologram area 3a travels. In more detail, the hologram area 3b deflects the light to create its focal point at a position different from the position where the focal point is created by the hologram area 3a. The hologram areas 3a and 3b correspond to “a first hologram area” and “a second hologram area” of the present invention, respectively. The light via the hologram area 3a corresponds to “a first image information light”, and the light via the hologram area 3b corresponds to “a second image information light”.

By forming the hologram areas 3a and 3b in this manner, the hologram area 3a and the hologram area 3b create the focal points at the positions different from each other. Specifically, as shown in FIG. 1A, the hologram area 3a creates the focal point at the point P1a, and the hologram area 3b creates the focal point at the point P1b. In this case, the hologram areas 3a and 3b create the focal points P1a and P1b at positions apart from each other by certain degree such that the light passed through the hologram area 3a and the light passed through the hologram area 3b are not irradiated on the pupil at the same time. Thus, it is possible to prevent that the image information by the different hologram areas 3a and 3b are visually recognized at the same time. The focal point P1a is created at the position corresponding to the pupil position when the eyeball of the user is directed to the front, and the focal point P1b is created at the position corresponding to the pupil position when the eyeball of the user is directed to a certain direction other than the front.

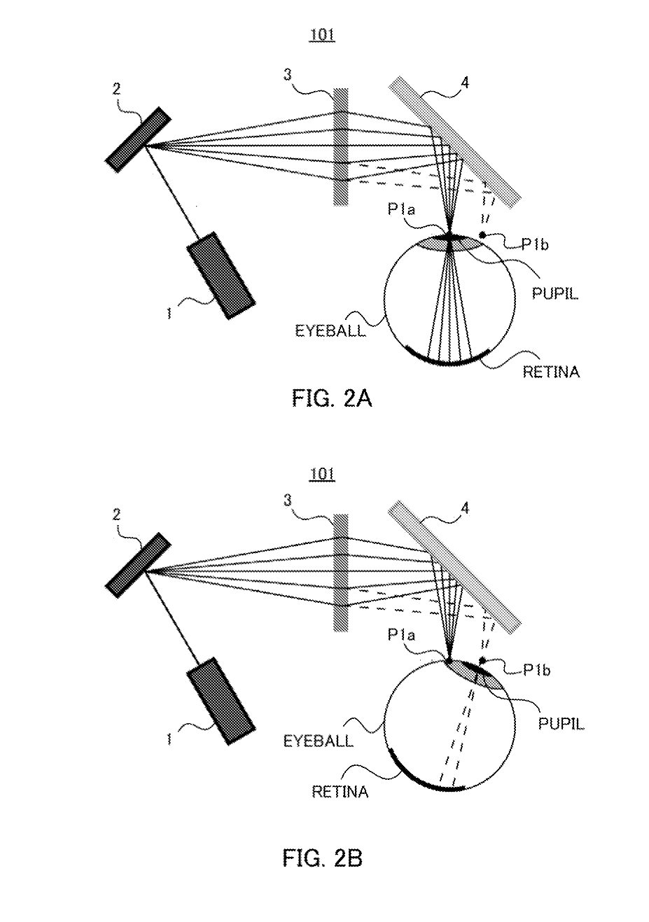

FIGS. 2A and 2B are diagrams for specifically explaining the operation by the first embodiment described above. FIG. 2A shows the diagram when the eyeball of the user is directed to the front. In this state, the pupil of the user is positioned in the vicinity of the focal point P1a created by the hologram area 3a, and is apart from the focal point P1b created by the hologram area 3b. Therefore, only the light passed through the hologram area 3a is concentrated on the vicinity or the pupil. Accordingly, only the image corresponding to the light passed through the hologram area 3a (corresponding to “a first image”) is projected on the retina, and the image corresponding to the light passed through the hologram area 3b is not projected on the retina.

FIG. 2B shows the diagram when the eyeball of the user is directed to a certain direction other than the front. In this state, the pupil of the user is positioned in the vicinity of the focal point P1b created by the hologram area 3b, and is apart from the focal point P1a created by the hologram area 3a. Therefore, only the light passed through the hologram area 3b is concentrated on the vicinity of the pupil. Accordingly, only the image corresponding to the light passed through the hologram area 3b (corresponding to “a second image”) is projected on the retina, and the image corresponding to the light passed through the hologram area 3a is not projected on the retina.

Since the hologram area 3a has a relatively large size as shown in FIG. 1B, when the eyeball of the user is directed to the front, the entire image formed by the image display device 101, for example, is visually recognized as the image (the first image) projected on the retina by the light via the hologram area 3a. In contrast, since the hologram area 3b is formed at the position apart from the center of the hologram element 3 and has a relatively small size as shown in FIG. 1B, when the eyeball of the user is directed to the direction other than the front, a part of the image formed by the image display device 101, for example, is visually recognized as the image (the second image) projected on the retina by the light via the hologram area 3b. Therefore, if the user changes the direction of the eyeball between the front and the certain direction other than the front, the image visually recognized by the user changes between the entire part and a part of the image formed by the image display device 101, for example. In this specification, the entire part and a part of the image formed by the image display device 101 are treated as different images, because the size of the image and the range of the presented image information are different between the entire part and a part of the image formed by the image display device 101.

As described above, according to the first embodiment, the image information observed by the user can be changed in accordance with the pupil position of the user. Namely, when the visual line direction of the user changes, it is possible to make the user visually recognize different images.

If the image information capable of observing a broad visual field is given at the focal point P1a created by the hologram area 3a, when the user tries to observe the circumference of the image information, the pupil becomes apart from the vicinity of the focal point P1a and the image information tends to be not observable. Therefore, it is preferred that the hologram area 3b is formed on the hologram element 3 in consideration of the correspondence between the center visual field and the circumferential visual field. Specifically, it is preferred that the hologram area 3b is formed such that, when the circumference is observed, the image information corresponding to the visual line direction at that time is observed.

It is more preferable that the position of the hologram area 3b formed on the hologram element 3 is determined in consideration of the movement direction of the eyeball of the user (i.e., the movement direction of the pupil). Namely, the hologram area 3b is preferably formed on the hologram element 3 such that the positional relationship between the focal point P1a created by the hologram area 3a and the focal point 3b created by the hologram area 3b generally corresponds to the positional relationship on the image between the first image formed by the hologram area 3a and the second image formed by the hologram area 3b. Specifically, it is preferable to form the hologram area 3b on the side corresponding to the movement direction of the eyeball on the hologram element 3.

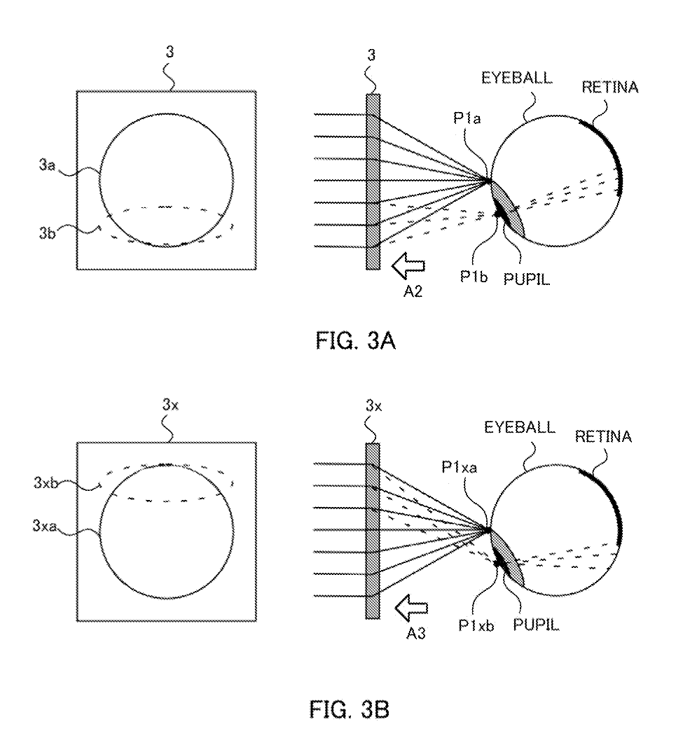

FIGS. 3A and 35 are diagrams for explaining the formation of the hologram area 3b in consideration of the movement direction of the user's eyeball. Here, for convenience of the explanation, the description will be given by using the optical system from which the beam splitter 4 is omitted.

FIG. 3A shows the hologram element 3 in which the hologram area 3b is formed on the same side as the rotational movement direction of the user's eyeball. Specifically, the right part of FIG. 3A shows the state in which the pupil is positioned at the vicinity of the focal point P1b created by the hologram area 3b, and the left part of FIG. 3A shows the view observing the hologram element 3 in the direction of the arrow A2. In the case where the hologram area 3b is formed as shown in FIG. 3A, when the eyeball rotationally moves from the state in which the pupil is positioned in the vicinity of the focal point P1a to the state in which the pupil is positioned in the vicinity of the focal point P1b, the image (the second image) formed by the hologram area 3b provided on the same side as the rotational movement direction of the eyeball is visually recognized. Specifically, when the eyeball rotationally moves such that the pupil is directed downwardly, the lower part of the image formed by the image display device 101 is visually recognized. In this case, the user does not have a wrong feeling.

In contrast, FIG. 3B shows the hologram element 3x in which the hologram area 3xb is formed on the side opposite to the rotational movement direction of the user's eyeball, as a comparative example with the configuration shown in FIG. 3A. Specifically, the right part of FIG. 3B shows the state in which the pupil is positioned in the vicinity of the focal point P1xb created by the hologram area 3xb, and the left part of FIG. 3B shows the view observing the hologram element 3x in the direction of the arrow A3. In the case where the hologram area 3xb is formed as shown in FIG. 3B, when the eyeball rotationally moves from the state in which the pupil is positioned in the vicinity of the focal point P1xa to the state in which the pupil is positioned in the vicinity of the focal point P1xb, the image formed by the hologram area 3xb provided on the side opposite to the rotational movement direction of the eyeball is visually recognized. Specifically, when the eyeball rotationally moves such that the pupil is directed downwardly, the upper part of the image formed by the image display device 101 is visually recognized. in this case, the user has a wrong feeling.

As can be understood from the above description, by forming the hologram area 3b on the hologram element on the side corresponding to the movement direction of the eyeball, a wrong feeling as described with reference to FIG. 3B can be suppressed. While the above description shows the example in which the hologram element 3 is formed such that the lower part of the image formed by the image display device 101 is visually recognized when the eyeball rotationally moves to direct the pupil downward, the hologram element 3 may be formed such that the upper part of the image formed by the image display device 101 is visually recognized when the eyeball rotationally moves to direct the pupil upward. The same applies for the other directions (e.g., the right direction and the left direction).

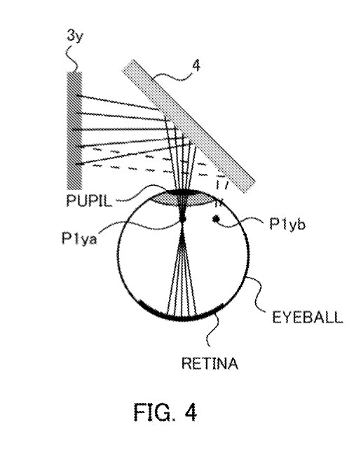

While the focal points P1a, P1b are positioned generally on the pupil, it is not necessary to create the focal points on the pupil. FIG. 4 shows an example in which the focal points P1ya, P1yb are not positioned on the pupil. In FIG. 4, the illustration of the laser light source 1 and the scan mechanism 2 is omitted. In this example, the hologram element 3y creates the focal points P1ya, P1yb at the positions of the eyeball inside the pupil by using two hologram areas (similar to the hologram areas 3a, 3b) In the case of forming the focal points P1ya, P1yb, it is desired to form the hologram element 3y so that the light flux corresponding to the focal points P1ya, P1yb are not irradiated on the pupil at the same time. This is because, if the light flux corresponding to the focal points P1ya, P1yb are irradiated on the pupil at the same time, the image information by the different hologram areas are visually recognized at the same time.

### 2nd Embodiment

Next, a second embodiment will be described. The second embodiment is different from the first embodiment described above in the configuration of the image display device. Specifically, while the hologram element 3 is formed as a transmission-type in the first embodiment, the hologram element is formed as a reflection-type in the second embodiment.

In the following, the description of the configuration same as the first embodiment will be omitted for convenience. It is assumed that the configuration not particularly described here is the same as the first embodiment.

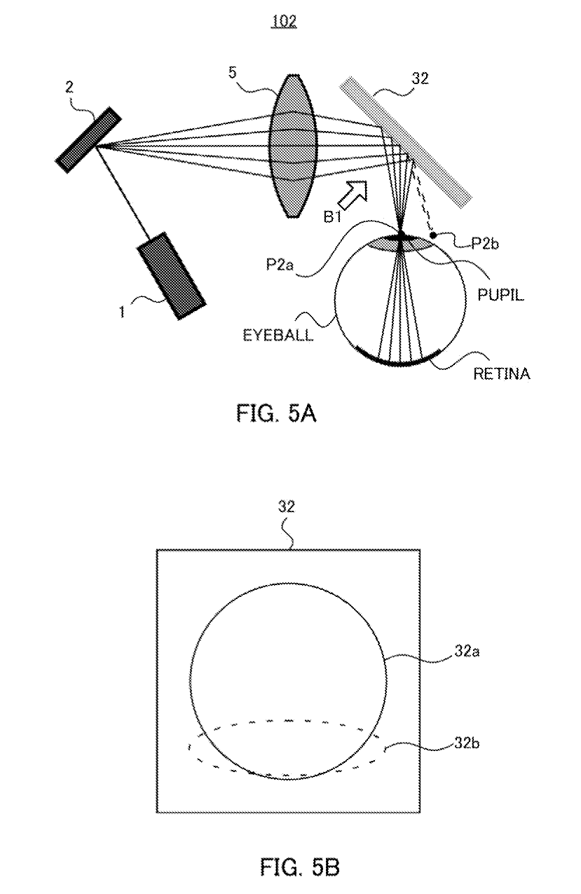

FIGS. 5A and 5B are diagrams schematically showing the configuration of the image display device 102 according to the second embodiment. As shown in FIG. 5A, the image display device 102 according to the second embodiment has the different configuration from the image display device 101 according to the first embodiment in that it includes a lens 5 and a hologram element 32 instead of the hologram element 3 and the beam splitter 4. The hologram element 32 may have an optical transparency.

The lens 5 concentrates the laser light from the scan mechanism 2 and outputs it to the hologram element 32. The hologram element 32 is formed as a reflection-type, and reflects the laser light from the lens 5 to the eyeball of the user.

FIG. 5B is a view observing the hologram element 32 in the direction of the arrow B1 in FIG. 5A. As shown in FIG. 5B, the hologram element 32 has two hologram area 32a, 32b. The shape and arrangement of the hologram area 32a, 32b are the same as the hologram areas 3a, 3b in the first embodiment. Both of the hologram areas 3a, 3b have the function of deflecting the incident light. Specifically, the hologram areas 32a, 32b deflect the incident light to different directions, respectively. In detail, the hologram areas 32a, 32b deflect the incident light such that the lights deflected by them form focal points at different positions. The hologram areas 32a, 32b correspond to an example of “a first hologram area” and “a second hologram area”, respectively, in the present invention.

By forming the hologram area in this manner, as shown in FIG. 5A, the hologram area 32a creates the focal point at the point P2a and the hologram area 32b creates the focal point at the point P2b. In this case, the hologram areas 32a, 32b create the focal points P2a, P2b at positions apart from each other by a certain distance so that the light via the hologram area 32a and the light via the hologram area 32b are not irradiated on the pupil at the same time. In detail, the hologram area 32a creates the focal point P2a in the vicinity of the pupil position when the eyeball of the user is directed to the front, and the hologram area 32b creates the focal point P2b in the vicinity of the pupil position when the eyeball of the user is directed to the direction other than the front.

Also by the second embodiment described above, the image observable by the user can be changed in accordance with the pupil position of the user.

### 3rd Embodiment

Next, a third embodiment will be described. The third embodiment is different from the it and second embodiments described above in the configuration of the image display device. Specifically, while the image display devices 101, 102 are configured as a scanning-type display, the image display device is configured as a projection-type display in the third embodiment.

In the following, the description of the configuration same as the first embodiment will be omitted for convenience. It is assumed that the configuration not particularly described here is the same as the first embodiment.

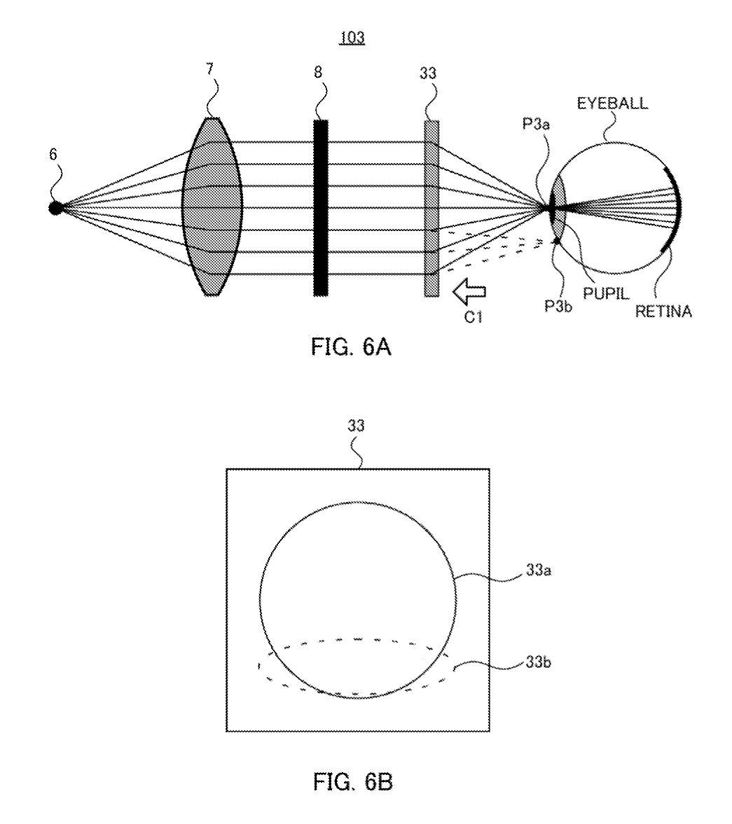

FIGS. 6A and 6B are diagrams schematically showing the configuration of the image display device 103 according to the third embodiment. As shown in FIG. 6A, the image display device 103 according to the third embodiment has the different configuration from the image display device according to the first embodiment in that it does not include the laser light source 1, the scan mechanism 2, the hologram element 3 and the beam splitter 4, but it includes a light source 6, a lens 7, a transmission object 8 and a hologram element 33.

The light source 6 is a point light source and emits the light to the lens 7. The light source 6 corresponds to an example of “an output unit” in the present invention. The lens 7 converts the light from the light source 6 to a parallel light flux, and outputs the parallel light flux to the transmission object 8. The transmission object 8 is formed by a spatial light modulator for example, and transmits the parallel light flux from the lens 7 to output it to the hologram element 33. As the spatial light modulator of the transmission object 8, a LCD (Liquid Crystal Display) may be used.

The hologram element 33 is formed as the transmission-type, and concentrates the parallel light flux from the transmission object 8 to output it to the eyeball of the user. By this, the light is concentrated on the vicinity of the user s pupil and projected on the retina of the user. As a result, the image formed by the image display device 103 is visually recognized by the user.

FIG. 6B is a view observing the hologram element 33 in the direction of the arrow C1 in FIG. 6A. As shown in FIG. 6B, the hologram element 33 has two hologram areas 33a, 33b. The shape and arrangement of the hologram areas 33a, 33b are the same as the hologram areas 3a, 3b in the first embodiment. The hologram area 3a has a function of concentrating the incident light, and the hologram area 3b has a function of not only concentrating but also deflecting the incident light. Specifically, the hologram area 33b deflects the incident light such that the light outputted from the hologram area 33b travels in the direction different from the direction in which the light outputted from the hologram area 33a travels. In mote detail, the hologram area 33b deflects the incident light to create the focal point at the position different from the position of the focal point formed by the hologram area 33a. The hologram areas 33a, 33b correspond to examples of “a first hologram area” and “a second hologram area”, respectively, in the present invention.

By configuring the hologram areas 33a, 33b in this manner, as shown in FIG. 6B, the hologram area 33a creates the focal point at the point P3a, and the hologram area 33b creates the focal point at the point P3b. In this case, the hologram areas 33a, 33b create the focal points P3a, P3b at the positions apart from each other by a certain distance so that the light via the hologram area 33a and the light via the hologram area 33b are not irradiated on the pupil at the same time. In detail, the hologram area 33a creates the focal point P3a in the vicinity of the pupil position when the eyeball of the user is directed to the front, and the hologram area 33b creates the focal point 93b in the vicinity of the pupil position when the eyeball of the user is directed to a certain direction other than the front.

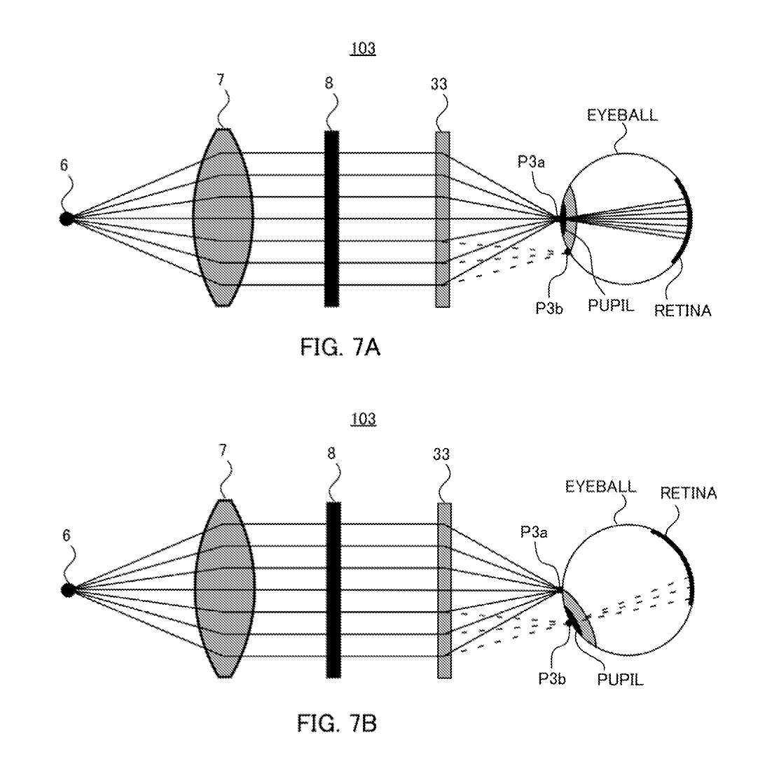

FIGS. 7A and 7B are diagrams for specifically explaining the operation by the third embodiment described above. FIG. 7A is a diagram when the eyeball of the user is directed to the front. In this state, the pupil of the user is positioned in the vicinity of the focal point P3a created by the hologram area 33a, and is apart from the focal point P3b created by the hologram area 33b. Therefore, only the light passed through the hologram area 33a is concentrated on the vicinity of the pupil. Accordingly, only the image the first image) corresponding to the light via the hologram area 33a is projected on the retina, and the image corresponding to the light via the hologram area 33b is not projected on the retina.

In contrast, FIG. 7B is a diagram when the eyeball of the user is directed to the certain direction other than the front. In this state, the pupil of the user is positioned in the vicinity of the focal point P3b created by the hologram area 33b, and is apart from the focal point P3a created by the hologram area 33a. Therefore, only the light passed through the hologram area 33b is concentrated on the vicinity of the pupil. Accordingly, only the image (the second image) corresponding to the light via the hologram area 33b is projected on the retina, and the image corresponding to the light via the hologram area 33a is not projected on the retina.

As understood from FIGS. 7A and 7B, when the user changes the direction of the eyeball between the front and the certain direction other than the front, the image visually recognized by the user is changed between the entire part and a part of the image formed by the image display device 103, for example. Accordingly, also by the third embodiment, the image information observable by the user can be changed in accordance with the pupil position of the user.

### Modified Examples

Next, modified examples of the above embodiments will be described. The modified examples presented below may be appropriately exercised in combination with the embodiments described above. For example, the modified examples may be applied to not only the scanning-type display but also the projection-type display.

In the following, the description of the configuration same as the first embodiment described above will be omitted. It is assumed that the configuration not particularly described is the same as the first embodiment.

### 1st Modified Example

In the first modified example, a single hologram element has the function of the hologram element 3 and the beam splitter 4 shown in the first embodiment.

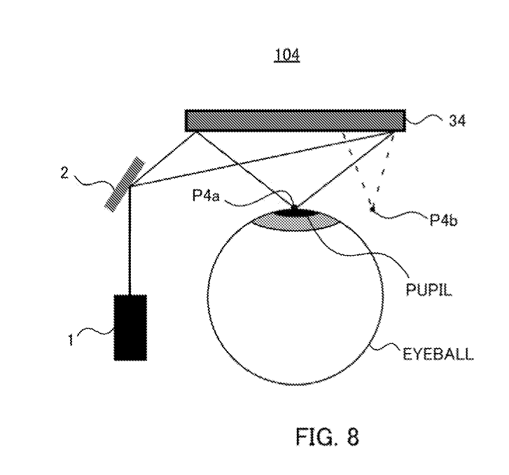

FIG. 8 is a diagram schematically showing the configuration of the image display device 104 according to the first modified example. As shown in FIG. 8, the image display device 104 according to the first modified example as a different configuration from the image display device 101 of the first embodiment in that it include a single hologram element 34 instead of the hologram element 3 and the beam splitter 4.

The hologram element 34 is formed to have the basic function of both the hologram element 3 and the beam splitter 4 in the first embodiment. Specifically, the hologram element 34 is formed as the reflection-type, and deflects the light from the scan mechanism 2 to the eyeball of the user. Similarly to the first embodiment, the hologram element 34 has two hologram areas, wherein one hologram area creates the focal point at the point P4a and the other hologram area creates the focal point at the point P4b.

According to the first modified example described above, since the hologram element 34 has plural optical functions, the number of the optical parts can be reduced and the image display device 104 can be downsized.

### 2nd Modified Example

The second modified example is different from the first embodiment described above in that the hologram areas are formed not to be overlapped with each other on the hologram element and that three hologram areas are formed on the hologram element.

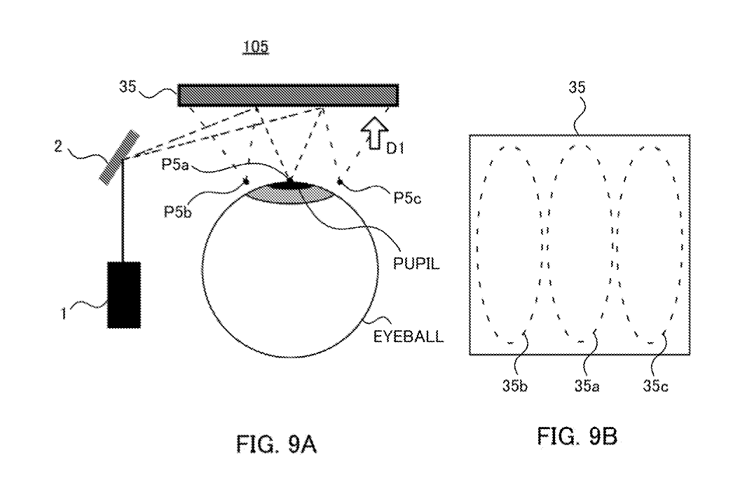

FIG. 9 is a diagram schematically showing the configuration of the image display device 105 according to the second modified example. As shown in FIG. 9A, similarly to the image display device 104 according to the first modified example, the image display device 105 according to the second modified example has a single hologram element 35 instead of the hologram element 3 and the beam splitter 4 shown in the first embodiment. Namely, the hologram element 35 has the basic function of both the hologram element 3 and the beam splitter 4 shown in the first embodiment.

FIG. 9B is a view observing the hologram 35 in the direction of the arrow D1 in FIG. 9A. As shown in FIG. 9B, the hologram element 35 has three hologram areas 35a, 35b, 35c. The hologram area 35a is formed at the center of the hologram element 35, and the hologram areas35a and 35c are formed at the positions apart from the center of the hologram element 35. The hologram areas 35a, 35b, 35c have generally the same size and are not overlapped with each other.

As shown in FIG. 9A, the hologram areas 35a, 35b, 35c create the focal points at the points P5a, P5b, P5c, respectively. Specifically, the hologram area 35a creates the focal point P5a at the vicinity of the pupil position when the eyeball of the user is directed to the front, and the hologram areas 35b, 35c create the focal points P5b, P5c at the vicinity of the pupil position when the eyeball of the user is directed to the direction other than the front. In detail, the hologram area 35b creates the focal point P5b at the vicinity of the pupil position when the eyeball is directed to the left direction in FIG. 9A, and the hologram area 35c creates the focal point P5c at the vicinity of the pupil position when the eyeball is directed to the right direction in FIG. 9A.

By forming the hologram areas 35a, 35b, 35c in a manner not overlapped with each other, when the pupil position of the user changes, it is possible to make the user visually recognize the image information of different contents. It is noted that, when the hologram areas 3a, 3b are overlapped. with each other as shown in the first embodiment, even if the pupil position of the user changes, the contents of the image information visually recognized are basically overlapped (However, the range of the image information visually recognized changes).

### 3rd Modified Example

The third modified example is different from the first embodiment described above in that it does not create the focal point by the hologram element at the vicinity of the pupil position when the eyeball of the user is directed to the front. Specifically, in the third modified example, the focal point by the hologram element is created only at the vicinity of the pupil position when the eyeball of the user is directed to the direction other than the front.

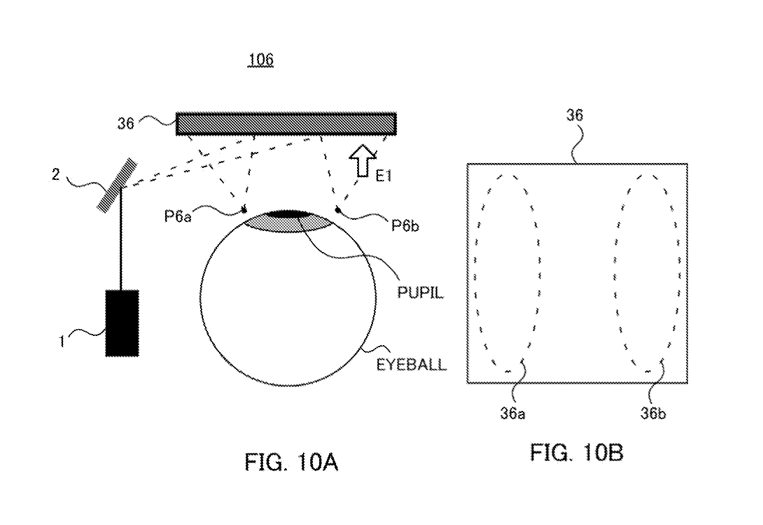

FIGS. 10A and 10B are diagrams schematically showing the configuration of the image display device 106 according to the third modified example. As shown in FIG. 10A, similarly to the image display device 104 according to the first modified example, the image display device 106 includes a single hologram element 36 instead of the hologram element 3 and the beam splitter 4 shown in the first embodiment. Namely, the hologram element 36 has the basic function of both the hologram element 3 and the beam splitter 4 shown in the first embodiment.

FIG. 10B is a view observing the hologram element 36 in the direction of the arrow E1 in FIG. 10A. As shown in FIG. 10B, the hologram element 36 has two hologram areas 36a, 36b. The hologram areas 36a, 36b are formed at the positions apart from the center of the hologram element 36. In addition, the hologram areas 36a, 36b generally have the same size, and are not overlapped with each other.

As shown in FIG. 10A, the hologram are 36a, 36b create the focal points at the points P6a, P6b, respectively. Specifically, both the hologram areas 36a, 36b create the focal points P6a, P6b at the vicinity of the pupil position when the eyeball of the user is directed to the direction other than the front. In detail, the hologram area 36a creates the focal point P6a at the vicinity of the pupil posit ion when the eyeball is directed to the left direction in FIG. 10A, and the hologram area 36b creates the focal point P6b at the vicinity of the pupil position when the eyeball is directed to the right direction in FIG. 10A.

By forming the hologram areas 36a, 36b in this manner, the image formed by the image display device 106 is not visually recognized when the eyeball is directed to the front, and the image formed by the image display device 106 can be visually recognized when the eyeball is directed to the direction other than the front. Namely, according to the third modified example, the image information can be observed only when the visual line is moved from the front.

In the third modified example, since the image information is observed only when the visual line is moved from the front, it is preferred to use an image to be appropriately presented when the visual line is directed to the direction other than the front. For example, it is preferred to use the image of contents auxiliary to the scene observed when the visual line is directed to the front. In one example, it is preferred to use the image of subtitles, and make the subtitles observable when the user directs the visual line to the direction other than the front.

### 4th Modified Example

While the above description shows the example in which two or three hologram areas are formed on the hologram element, four or more hologram areas may be formed on the hologram element. In addition, the size of the hologram area and/or the position of the hologram areas formed on the hologram element are not limited to the examples described above.

It is described in the above description that the hologram areas are formed so that the lights via two or more hologram areas are not irradiated on the pupil, thereby to prevent the image information from different hologram areas from being visually recognized at the same time. However, if two or more hologram areas do not overlap with each other, the lights via two or more hologram areas may be irradiated on the pupil. In this case, two or more image information of the same contents are visually recognized at the same time at the different positions on the visual line.

### 5th Modified Example

As the beam splitter 4 in the above embodiments, it is possible to apply a half mirror whose transmittance and reflectance are 50%, respectively.

As described above, the embodiment is not limited to those described above, and may be appropriately alterable within the range not contrary to the gist or idea of the invention readable from the claims and the specification.

### INDUSTRIAL APPLICABILITY

This invention can be used for an image display device such as a head-mount display.

### DESCRIPTION OF REFERENCE NUMERALS

1 Laser light source

2 Scan mechanism

3 Hologram element

3a, 3b Hologram area

4 Beam splitter

101 Image display device

1-16. (canceled)

17. An image display device comprising: an output unit which outputs an image information light corresponding to image information to be displayed; and a hologram element on which the image information light is incident, and projecting the image information light via the hologram element on a retina of one eye to make a user visually recognize an image,
wherein the hologram element includes a first hologram area and a second hologram area formed to extend along a surface on which the image information light is irradiated,
wherein the image information light outputted by the output unit is irradiated at least on an area on the hologram element where the first hologram area and the second hologram area are formed,
wherein a first image that a first image information light of the image information light via the first hologram area projects on the retina and a second image that a second image information light of the image information light via the second hologram area projects on the retina are different images, and
wherein the first image information light and the second image information light are concentrated on different positions, respectively.

18. The image display device according to claim 17, wherein the first image information light and the second image information light are concentrated on a vicinity of the pupil of one eye.

19. The image display device according to claim 18, wherein the first image information light and the second image information light are concentrated on different positions, respectively, such that one of the first image information light and the second image information light is projected on the retina in accordance with a movement of the one eye.

20. The image display device according to claim 18,
wherein the first image and the second image are included in the image information, and
wherein a positional relation between the first image and the second image in the image information generally corresponds to a positional relation between the first image information light concentrated and the second image information light concentrated.

21. The image display device according to claim 18,
wherein the first hologram area is formed to project the first image information light on the retina when the one eye is directed to a front, and
wherein the second hologram area is formed to project the second image information light on the retina when the one eye is directed a direction other than the front.

22. The image display device according to claim 18, wherein the first hologram area and the second hologram area are formed to project the first image information light and the second image information light on the retina when the one eye is directed to a direction other than a front.

23. The image display device according to claim 18, wherein the first hologram area and the second hologram area are formed to overlap with each other at least partly.

24. The image display device according to claim 18, wherein the first hologram area and the second hologram area are formed not to overlap with each other.

25. The image display device according to claim 18, wherein the first hologram area and the second hologram area deflect the incident image information light to different directions, respectively.

26. The image display device according to claim 18, wherein the hologram element is formed to transmit the incident image information light.

27. The image display device according to claim 18, wherein the hologram element is formed to reflect the incident image information light.

28. The image display device according to claim 27, wherein the hologram element has an optical transparency.

29. The image display device according to claim 18, wherein the image display device is a scanning-type display which makes the user visually recognize the image by scanning the image information light outputted by the output unit.

30. The image display device according to claim 18, wherein the image display device is a projection-type display which makes the user visually recognize the image by forming the image information light outputted by the output unit into a parallel light flux and passing the parallel light flux through a predetermined optical element.

31. An image display device for projecting an image information light corresponding to image information to be displayed and outputted by an output unit, on a retina of one eye via a hologram element including a first hologram area and a second hologram area,
wherein the first hologram area is formed to project a first image on the retina,
wherein the second hologram area is formed to project a second image on the retina,
wherein the hologram element includes a first hologram area and a second hologram area formed to extend along a surface on which the image information light is irradiated,
wherein the image information light outputted by the output unit is irradiated at least on an area on the hologram element where the first hologram area and the second hologram area are formed, and
wherein a first image information light of the image information light via the first hologram area and a second image information light of the image information light via the second hologram area are concentrated on different positions, respectively.

32. The image display device according to claim 31, wherein the first image and the second image are different images.
